(19) United States
(12) Patent Application Publication
(10) Pub. No.: US 2010/0153847 A1
(43) Pub. Date: Jun. 17, 2010

(54) USER DEFORMATION OF MOVIE CHARACTER IMAGES

(75) Inventor: Jody Fama, San Mateo, CA (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Computer Entertainment America Inc., Foster City, CA (US)

(21) Appl. No.: 12/337,096

(22) Filed: Dec. 17, 2008

(51) Int. Cl. G06F 3/00; H04N 5/93

(52) U.S. Cl. 715/719; 386/52

(57) ABSTRACT

A method or apparatus permits a user to input anatomical feature deformations of character images of a video or movie for display during the video or movie. The user views a video and may select particular anatomical features of the video. In response to the input, the method or apparatus generates a deformed anatomical feature corresponding to the selected anatomical feature. The deformed anatomical feature is displayed in place of the selected anatomical feature during the video. The method or apparatus may then automatically generate modifications of the deformed anatomical feature for display with additional frames of the video so that the modifications correspond to orientation and position changes of the selected anatomical feature in additional frames of the video.

### FIELD OF THE TECHNOLOGY

The present technology relates to video and motion pictures. More specifically, it relates to methods and systems for implementing user deformation of character images of video or movie.

### BACKGROUND OF THE TECHNOLOGY

Video and motion pictures are a popular form of entertainment. Video and movies can be distributed to viewers on recordable medium such as optical disks (e.g., DVD) or they may be downloaded as a video data file from a network. These may then by utilized for personal viewing on home entertainment equipment such as televisions, DVD players and computers. However, besides the act of viewing of the images of the scenes and characters of the videos, there is little more that a viewer can do with the video or movie. In fact, there is little or no opportunity for a viewer to interact with the character images of the movie or video.

### BRIEF DESCRIPTION OF THE DRAWINGS

The present technology is illustrated by way of example, and not by way of limitation, in the figures of the accompanying drawings, in which like reference numerals refer to similar elements including:

FIG. 1 is a conceptual illustration of an embodiment for enhancing a video or movie with viewer deformation of video or movie character images of the present technology;

FIG. 2 is a flow chart for an example algorithm for enhancing a video or movie with viewer deformation of character images;

FIG. 3 is a further conceptual illustration of an embodiment of the methodology for enhancing a video or movie with viewer deformation of character images of the present technology;

FIG. 4 is an example system diagram with components for implementing videos or movies with viewer deformation of character images;

FIG. 5 is a diagram illustrating various video player apparatus with technology for viewer deformation of character images of videos or movies; and

FIG. 6 illustrates an example deformation of an anatomical feature of a character image of a movie or video that may be implemented with the present technology;

FIG. 7 illustrates a further example deformation of a anatomical feature of a character image of a movie or video; and

FIG. 8 illustrates another example deformation of an anatomical feature of a character image of a movie or video.

### BRIEF SUMMARY OF THE TECHNOLOGY

One aspect of the present technology, involves methods for displaying a video. Frames of a video are displayed on a display. The displayed frames of the video include a character image having a first anatomical feature. An input is received with a user interface associated with the display. Then, in response to the input, a second anatomical feature is displayed corresponding to the first anatomical feature. The second anatomical feature comprises a deformation of the first anatomical feature. The second anatomical feature is then displayed in place of the first anatomical feature during the video.

In some embodiments, the generating of the second anatomical feature involves detecting pixels of the first anatomical feature of the video by scanning pixel data of a frame of the video. In some embodiments, the generating of the second anatomical feature involves accessing metadata associated with the first anatomical feature of the video. The metadata may be frame identifier data to identify a frame containing the first anatomical feature and position data to identify positioning of the first anatomical feature. The metadata may also include action data indicative of a deformation procedure for the first anatomical feature. In some embodiments, displaying of the second anatomical feature involves overlaying at least in part the second anatomical feature with the first anatomical feature. This may be accomplished without modifying any frames of the video.

In some embodiments, the displaying of frames of the video includes displaying a deformation area indicator to indicate an anatomical feature of the video that can be subjected to viewer deformation. Moreover, the input with the user interface may take the form of a command to generate the second anatomical feature by a change in size of the first anatomical feature. The input may also be a command to generate the second anatomical feature with a change in orientation of the first anatomical feature. Moreover, deformation data corresponding to the generated deformations of the first anatomical feature of the video may be stored in a file separate from the video. The stored file can be transmitted in a format to permit a viewer of another copy of the video to display the second anatomical feature in place of the first anatomical feature during the viewer's display of the copy of the video. In some embodiments, modifications of the second anatomical feature for display with additional frames of the video may be automatically generated. These modifications can correspond to orientation and position changes of the first anatomical feature in the additional frames of the video with respect to a first frame of the video. In some embodiments the video may comprise a motion picture.

Example embodiments can permit the first anatomical feature to be a nose of the character and the second anatomical feature to be a deformed version of the nose. In addition, the first anatomical feature may be an eye of the character and the second anatomical feature may be a deformed version of the eye. In some examples, the displaying of the second anatomical feature in place of the first anatomical feature can comprise a viewer induced jiggling of an anatomy of the character.

In some embodiments, some or all of the features of these methods may be embodied in a machine readable medium having processor control instructions. Thus, the processor control instructions can control a processor to display a video as previously discussed. The processor control instructions can also include instructions to display frames of a video on a display, the displayed frames of the video comprising a character image having a first anatomical feature. The processor control instructions may also control receiving an input with a user interface associated with the display. Moreover, the processor control instructions may control, in response to the input, generation of a second anatomical feature corresponding to the first anatomical feature, the second anatomical feature comprising a deformation of the first anatomical feature. The processor control instructions may then control displaying the second anatomical feature in place of the first anatomical feature during the video.

In some embodiments, some or all of the features of these methods may be embodied in a video player apparatus. The apparatus may typically include an output port to send signals to a video display. The apparatus may also include a user interface to receive an input with respect to an anatomical feature of a character image on the display. The apparatus may also have a processing means for controlling a display of frames of a video on a display where the video frames include a character image having a first anatomical feature. The processing means may be configured for generating a second anatomical feature corresponding to the first anatomical feature in response to the input of the user interface. The second anatomical feature may be a deformation of the first anatomical feature. In addition, the processing means may also be configured for displaying the second anatomical feature in place of the first anatomical feature during the video.

Further embodiments and features of the technology will be apparent from the following detailed disclosure, abstract, drawings and the claims.

### DETAILED DESCRIPTION

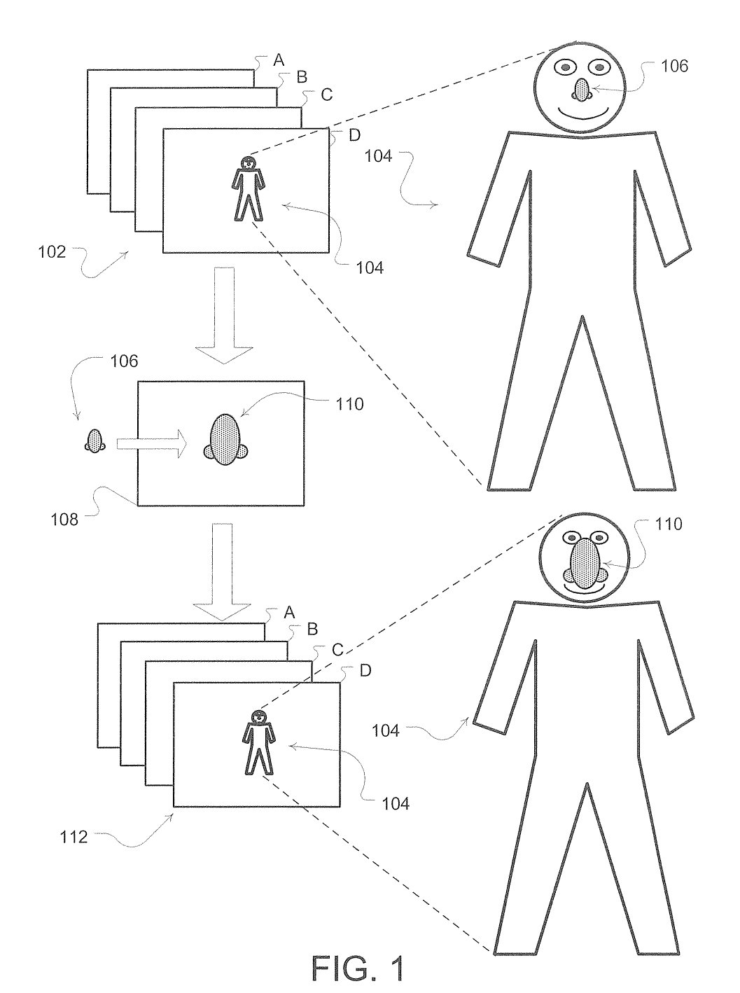

An example implementation of the present video or movie character image deformation technology is illustrated in FIG. 1. A movie or video 102 having image frames A, B, C, D will typically include one or more character images 104 when it is displayed with a video player apparatus. For example, the movie or video may include frames having captured images of person playing the role of a Peter Parker character of a Spiderman movie. Such an image may, for example, be taken with a digital video recorder or movie camera. Thus, although the character image 104 of FIG. 1 is a graphic illustration that is provided for purposes of explaining the present technology, the illustration is intended to represent the captured image of a character of a movie film or video.

Typically, the character image 102 of the frames of the video or movie will also include anatomical features such as the anatomical feature 106 shown in FIG. 1. For example, the anatomical feature 106 illustrated in FIG. 1 is a nose portion of the character image 104. It will be understood that a character image will typically include additional anatomical features. During the course of the usual presentation or display of the frames of the video, the anatomical feature 106 and other such features will be displayed on the screen from different perspectives such as different positions, different angles and different zooms. In such a display, the anatomical features of the character will vary according to the captured perspectives of the character in the movie or film.

In accordance with an embodiment of the present technology, during a presentation of the film or movie frames 102 one or more deformed anatomical features of the character images may be displayed by a video player apparatus in place of the original anatomical feature of a character image of the video or film. For example, as illustrated in FIG. 1, based on viewer input associated with the frames of the original movie or film, such as a user selection of the anatomical feature 106, a deformed anatomical feature image 108 may be generated. In the example, the nose anatomical feature 106 is expanded to form the deformed anatomical feature 110 as an image of an enlarged nose. This may be generated in the deformed anatomical feature image 108. The deformed anatomical feature image 108 may then be displayed in place of one or more frames of the movie or video during the presentation of the movie. For example, the deformed anatomical feature image 108 may overlay the original frame of the movie or video during its presentation to the viewer. In this way, the original anatomical feature will appear in the presentation as a different deformed version compared to the way that it appears in the original film or video.

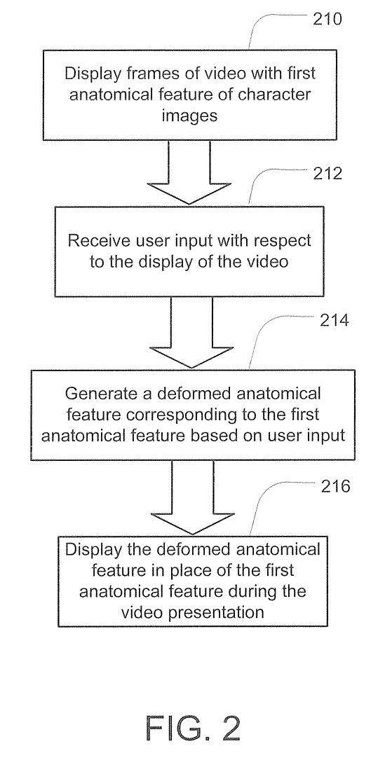

Example steps of the methodology of a video player apparatus of the present technology are in the flow chart of FIG. 2. In 210, frames of a video with a first anatomical feature of a character image are displayed with a video payer apparatus. In 212, a viewer of the display may initiate a deformed character generation mode of the video player device with respect to the video such as by selecting the first anatomical feature to be deformed with a user interface of a video player device. In 214, based on the viewer input, a deformed anatomical feature is generated by the video player device so that the deformed anatomical feature corresponds to the first anatomical feature. In 216, the video player apparatus may then display the deformed anatomical feature in place of the first anatomical feature during the video presentation.

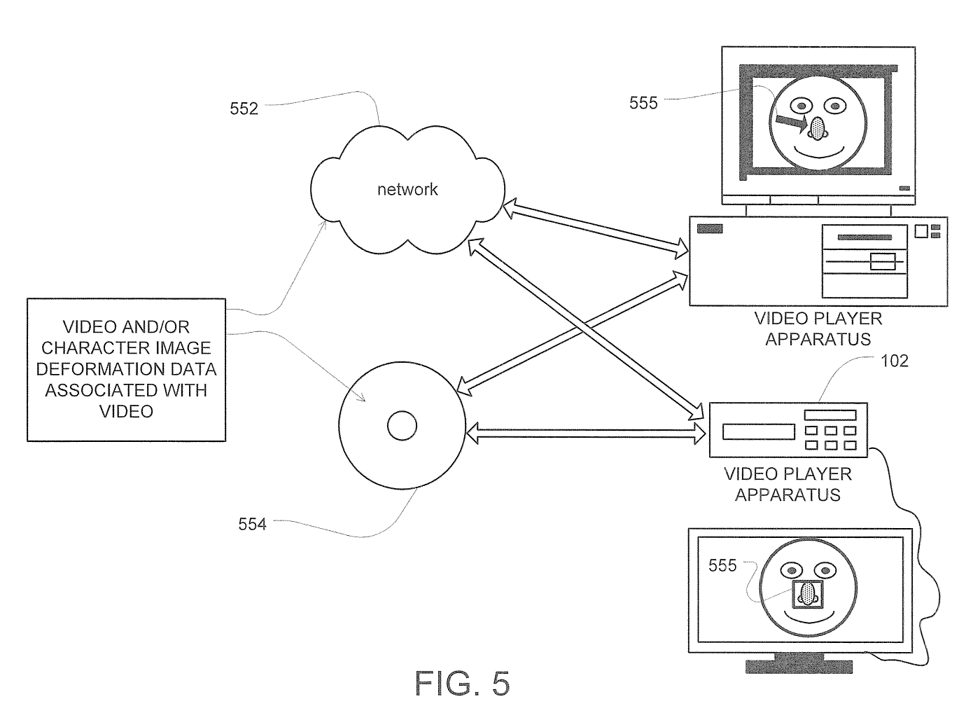

In an example embodiment of the methodology, a viewer of a video played on a video player apparatus may operate a user interface or other input device, such as a mouse, keyboard, remote control etc., to identify an anatomical feature of a character image of the video frame. Such identification may optionally involve the viewer manipulating the user interface to control a graphical selector on a display controlled by the video display apparatus. Such a graphical selector (illustrated as selector 555 in FIG. 5) may be pointer or area selector such as an outline of a bounding box. The activation of the graphical selector can be associated with a position or area within a frame of the video. Upon the activation of the selector by the user, an anatomical feature of the character image can then be identified in relation to the position or area of the graphic selector.

For example, the image pixel data of a frame of the video may be automatically scanned by the video player apparatus within the selected area of the graphic selector to identify pixel data associated with an anatomical feature in the selected area. For example, facial features may be identified by implementing a recognition algorithm such as a face recognition algorithm or an iris recognition algorithm. Similarly, a nose anatomical feature may be identified by its typical positional relationship with respect to eye pixel data determined with the eye or iris recognition algorithm.

Alternatively or in addition thereto, metadata concerning the video pixel data for one or more anatomical features may be accessed based on the position or area of the frame of the video selected by the viewer with the graphic selector. In this regard, the metadata may contain information concerning the anatomical features of characters of the frames of the video to permit user deformation of particular anatomical features of the video. Thus, metadata may be provided for one or more frames of the video or movie or for each frame that includes one or more anatomical features for user deformation. For example, the metadata may contain position information for the pixels of a frame that depicts an anatomical feature. The position information may be considered a bounding box or active area for a deformable anatomical feature. The metadata for a frame may have more than one such bounding box depending on the number of deformable anatomical features. The metadata may also optionally contain data to represent action procedures that may be taken with respect to the anatomical feature such as enlarge, stretch, shrink, skew, rotate, pitch, roll, etc. Optionally, the metadata may contain three dimensional object data as discussed in more detail herein. For example, the metadata may include z-axis data for each bounding box of each frame of a deformable anatomical feature to assist with deformation or adjustment of the anatomical feature in accordance with relative camera angle adjustments that may exist across several frames of the video that include the particular anatomical feature. In this way, certain anatomical features may be tagged for viewer deformation by providing metadata for one or more particular anatomical features and their association with the video or the frames of the video. This metadata may be stored together with or separate from the file containing the pixel data of the video.

Thus, in response to the selection, a person watching the video or video viewer may then control the user interface to change an appearance of the selected anatomical feature. For example, the video viewer might drag a portion of the selected anatomical feature of the frame to stretch, skew, rotate, etc. or otherwise deform the selected anatomical feature. Thus, the anatomical feature may appear different from the original version of the anatomical feature. Moreover, while the anatomical feature may be so deformed, the other features of the scene of the frame of the video and the remainder of the character's unselected anatomical features would remain unchanged.

In one embodiment, the video player apparatus may then display the deformed anatomical feature by generating a deformed overlay image with pixel data of the anatomical feature. The apparatus may then overlay the generated pixel data at a position associated with the pixel data of the original anatomical feature when it is displayed by the video player apparatus with the original frame data that depicts the original anatomical feature. Moreover, while the original video frame data may be modified, this display may optionally be accomplished without changing any image data of the frames of the original video that has the original anatomical feature(s). Thus, the deformation data associated with the deformation image may be stored separately from the data of the video and may simply be displayed at the appropriate time in conjunction with the original frames of the video. Thus, the deformation data created by a user may optionally include frame number(s) of the video for which the deformed image should be displayed, position information for where it should be displayed in each frame, and pixel data for generating the deformed anatomical feature. In some embodiments, this may optionally be accompanied by the metadata of the video as previously discussed.

In some embodiments, after a viewer-initiated deformation of a particular anatomical feature of a particular frame, the video display apparatus may automatically generate further changes or transformations to the deformed anatomical feature for subsequent frames of the video so that the selected deformation may appropriately transform in correspondence with appearance changes of the original character or anatomical feature in the subsequent frames of the original video. These adjustments may be accomplished automatically in the sense that no further user modification would need to be made after a deformation was made by the user with respect to an image of a prior frame.

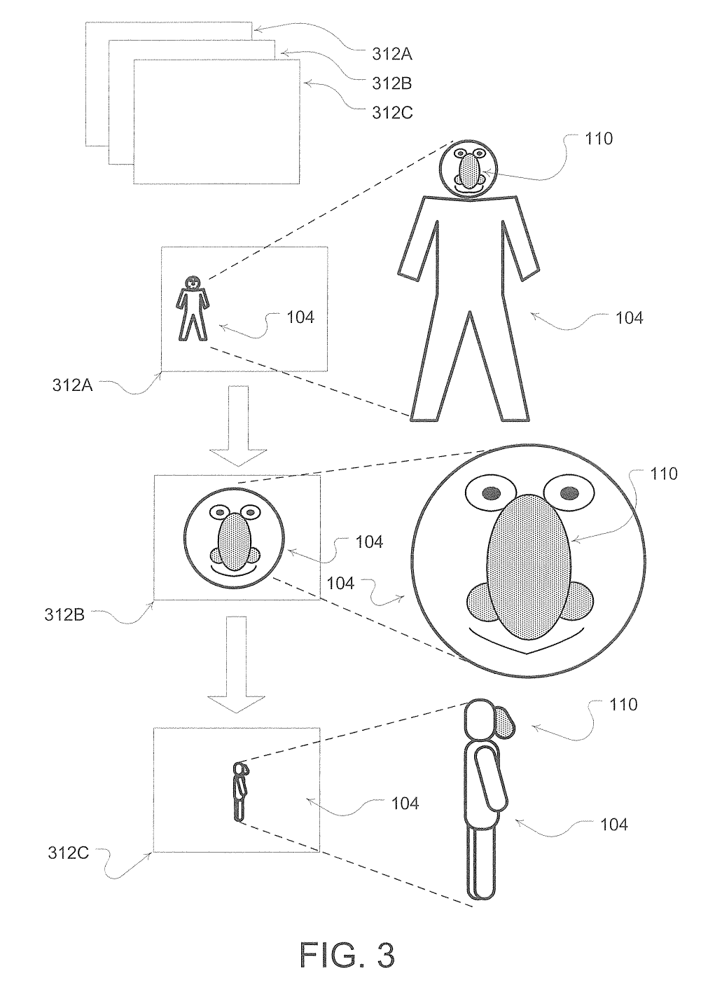

For example, as an unmodified video is displayed in subsequent frames, a camera (view) angle, zoom, field of view etc. may change or even the character itself may move in the field of view of the video. To match these changes so that the deformed feature may continue to correspond to the original feature, the deformed anatomical image feature may be modified to match the camera angle change, zoom change, etc. or even position change of the character of the original frames of the video. As illustrated in FIG. 3, in subsequent video frames 312A, 312B, 312C, different automatic changes to the deformed images may be generated by the video player apparatus for display. For example, in frame 312A, the character image 104 has changed its position from the position of an earlier frame of the video 102 shown in FIG. 1. Thus, the deformed anatomical feature 110 may also be displayed with a relative position change in the subsequent frame or frames as shown in frame 312A. Similarly, when the camera has changed a zoom for the character, a comparable increase or decrease in the zoom of the deformed anatomical feature 110 may be automatically generated as illustrated in subsequent image frame 312B. Still further, automatic changes may be generated based on camera angle or orientation changes as illustrated in subsequent video frame 312C. Thus, in the event that a front view becomes a side view of a character of the original video, a comparable camera angle adjustment may be made to the deformed anatomical feature 110 image on a frame by frame basis so that it may be displayed from the comparable camera angle as the original anatomical feature of the character image. For example, in some embodiments, data of the deformed anatomical feature 110 may include three dimensional object data. Thus, changes to the anatomical feature object data for the overlay, such as the view angle, may be implemented by different transformations of the three dimensional object data and may be automatically performed by the video player apparatus on a frame by frame basis.

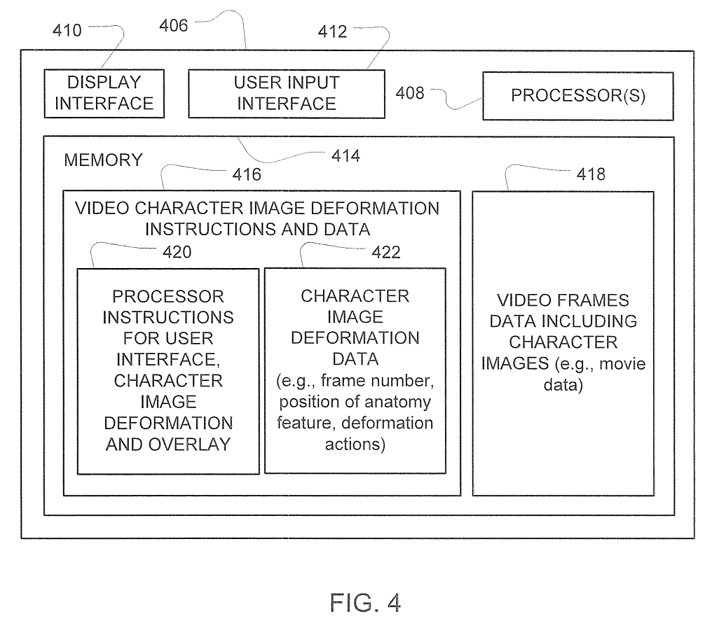

These deformation methodologies may be implemented as hardware and/or software in a video player apparatus. For example, FIG. 4 shows suitable components of a video player apparatus 406 that may generate anatomical image deformations in accordance with the previously described embodiments. In the example, the video player apparatus 406 includes one or more processor(s) 408 such as a programmable microprocessor, CPU, DSPs, ASICs etc. to execute the algorithms previously discussed. The player apparatus 406 will also typically include a display interface 410 for transferring video output signals to a display such as an LCD, CRT, plasma, etc. with a viewing screen to show the frames of the video in combination with the anatomical deformations. The video player apparatus 406 will also typically include a viewer or user input interface 412 to permit a user to control the apparatus such as with a remote control, keyboard and/or mouse etc. Similarly, although not shown, the player apparatus may also optionally include other input and output components such as a memory card or memory device interface, magnetic and/or optical drives, communication devices (e.g., a modem, wired or wireless networking device, etc.). These components may permit input and output of video data and other data related to the anatomical deformations as previously discussed. In some embodiments, the video player apparatus 406 may even be a general or specific purpose computer such as a laptop computer, desktop computer, hand-held computer or programmable processing device, etc.

As illustrated in the embodiment of FIG. 4, the video player apparatus 406 can typically include data and processor control instructions in a memory 414 that control execution of the functions, methods, algorithms and/or routines as described herein. In some embodiments, these processor control instructions may comprise any set of instructions to be executed directly (such as machine code) or indirectly (such as scripts) by the processor(s). In that regard, the terms “instructions,” “steps”, “algorithm,” “methods” and “programs” may be used interchangeably herein. The instructions may be stored in object code for direct processing by a processor, or in any other computer language including scripts or collections of independent source code modules that are interpreted on demand or compiled in advance.

Accordingly, as illustrated in FIG. 4, the memory can include processor control instructions 420 for responding to the user input of the user interface. These instructions may also control the character image deformation in accordance with the user input deformations as well as the automatic frame by frame modifications or translations as previously described. Thus, these instructions will also control overlaying of the deformed anatomical feature images with the original frame of the video. In this regard, the memory 414 will also typically include character image deformation data 422 such as the metadata previously described. Moreover, to permit the overlay operations, the memory may also include video frames data 418 including the character images of the movie or video.

Such a video player apparatus can provide movie and video viewers with an even more enjoyable viewing experience from what has been previously available to movie or video viewers. For example, as illustrated in FIG. 5, a video data 550 may be received by the video player apparatus 506 on a recording medium 552 or by some other form of data communication such as a download or transfer from a network 554. The video data 550 may include data of a video and may be accompanied by metadata as previously discussed and/or deformation data that may be used with a video. The deformation data may also be in the metadata that facilitates the making of user deformations as previously discussed. Thus, a person may not only play the video but also play with the video by making anatomical deformations with the video player apparatus 506.

Moreover, with such a system, people can share their video anatomical deformations with others. For example, while viewing a video of a debate with a video player apparatus, a first user could deform some anatomical features of a character of the debate and then share those deformations with a friend by transferring the deformation data with or without the video to a friend who also has a video player apparatus. To this end, the video player apparatus may store or record the deformation data (with or without the metadata) or deformation images in a file that is separate from the video data of the debate. This separate storage can promote the efficient sharing or communication of the deformation data. Thus, when the friend views her own copy of the debate video, the friend's video player apparatus may be controlled by the user so that it utilizes the separate file with the deformation data to overlay or re-enact the deformation modifications generated by the first viewer with her video player apparatus. Such a stored file with deformation data and/or metadata may thus be in a format to permit a viewer of a different copy of the video to display the second anatomical feature in place of the first anatomical feature during the friend viewer's display of a different copy of the video. Typically, this may be accomplished with deformation data that associates the deformation images with frame identifications of the original video and/or positioning data within each frame.

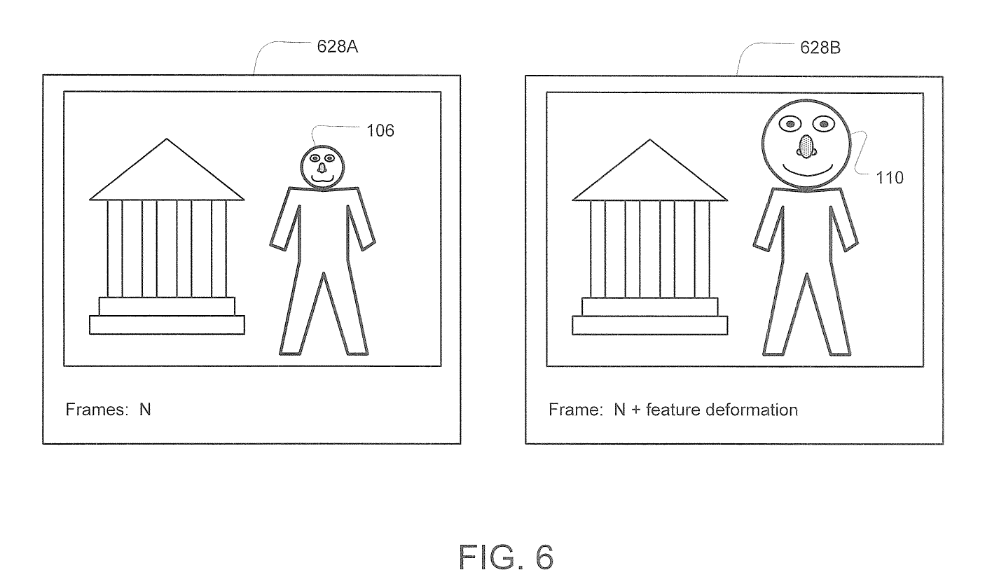

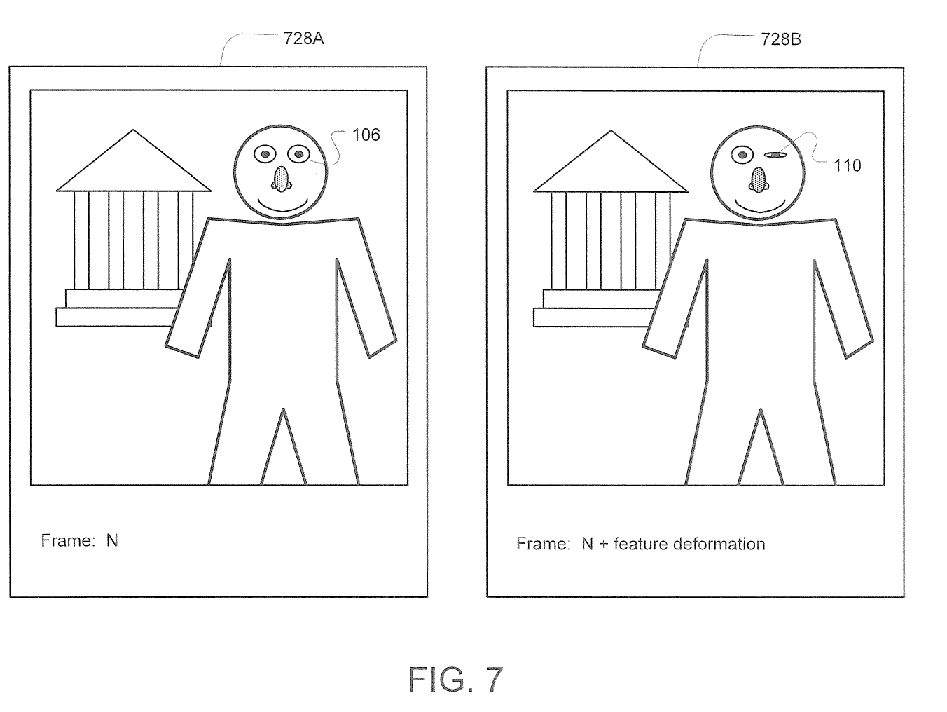

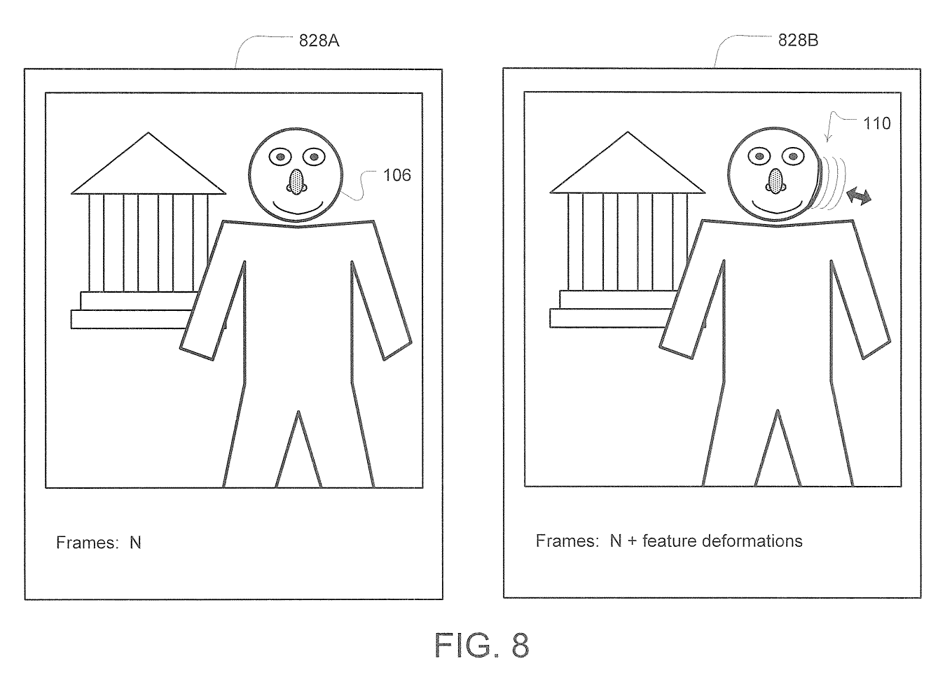

With such a video player apparatus that permits anatomical deformations of character images, many deformations may be created. For example, a user can inflate or expand a head of a character image of the video as illustrated with the modification of the original character frame 628A in FIG. 6. The overlaid frame 628B can then be seen with the user deformed image including the enlarged or inflated head. Similarly, a viewer can deform an eye of a character image of the video as illustrated with the modification of the original character frame 728A in FIG. 7. The overlaid frame 728B can then be seen with the user deformed image including a winking eye. Furthermore, even more advanced deformations can be implemented such as simulated movement deformations. For example, with the technology a user can implement a slapping action of an anatomical feature of the character image. Such an action is illustrated in FIG. 8. By activating a slapping action feature with the user interface, a user can simulate slapping of a selected anatomical feature such as a face of a character image of the video. In such an embodiment, the action can result in the video player apparatus generating several deformation image overlays of the anatomical feature of the character image across several frames of the video in a manner that simulates successive expansions and contractions associated with the user's selection of a particular anatomical feature. In such a way, the original video frames 828A can appear deformed with an anatomical feature responding to the simulated slap in a jiggling manner as illustrated in the deformed video frames 828B.

In the foregoing description and in the accompanying drawings, specific terminology and drawing symbols are set forth to provide a thorough understanding of the present technology. In some instances, the terminology and symbols may imply specific details that are not required to practice the technology. For example, although the terms “first” and “second” have been used herein, unless otherwise specified, the language is not intended to provide any specified order or count but merely to assist in explaining elements of the technology.

Moreover, although the technology herein has been described with reference to particular embodiments, it is to be understood that these embodiments are merely illustrative of the principles and applications of the technology. It is therefore to be understood that numerous modifications may be made to the illustrative embodiments and that other arrangements may be devised without departing from the spirit and scope of the technology. For example, in some embodiments, preset deformation image data may also be provided for selection by a user, which may then be overlaid with the anatomical images of the original video. This present deformation image data may then be associated with the metadata for the video. For example, pre-set deformation image data may represent alternative eyes, noses, ears, hair, accessories, etc. that may be overlaid with the original anatomical features of the characters of the video according to the metadata and the user selections.

1. A method of displaying a video comprising:
displaying frames of a video on a display, the displayed frames of the video comprising a character image having a first anatomical feature;
receiving an input with a user interface associated with the display;
in response to the input, generating a second anatomical feature corresponding to the first anatomical feature, the second anatomical feature comprising a deformation of the first anatomical feature; and
displaying the second anatomical feature in place of the first anatomical feature during the video.

2. The method of claim 1 wherein the generating the second anatomical feature further comprises detecting pixels of the first anatomical feature of the video by scanning pixel data of a frame of the video.

3. The method of claim 1 wherein the generating the second anatomical feature further comprises accessing metadata associated with the first anatomical feature of the video.

4. The method of claim 3 wherein the metadata comprises frame identifier data to identify a frame containing the first anatomical feature and position data to identify positioning of the first anatomical feature.

5. The method of claim 4 wherein the metadata further comprises action data indicative of a deformation procedure for the first anatomical feature.

6. The method of claim 1 wherein the displaying the second anatomical feature comprises overlaying at least in part the second anatomical feature with the first anatomical feature.

7. The method of claim 6 wherein the overlaying does not modify any frames of the video.

8. The method of claim 1 wherein the displaying frames of the video further comprises displaying a deformation area indicator to indicate an anatomical feature of the video that can be subjected to viewer deformation.

9. The method of claim 1 wherein the input comprises a command to generate the second anatomical feature with a change in size of the first anatomical feature.

10. The method of claim 1 wherein the input comprises a command to generate the second anatomical feature with a change in orientation of the first anatomical feature.

11. The method of claim 1 further comprising:
storing deformation data corresponding to the generated deformations of the first anatomical feature of the video in a file separate from the video.

12. The method of claim 11 further comprising transferring the file of the stored deformation data in a format to permit a viewer of another copy of the video to display the second anatomical feature in place of the first anatomical feature during the viewer's display of the copy of the video.

13. The method of claim 1 further comprising:
automatically generating modifications of the second anatomical feature for display with additional frames of the video, the modifications corresponding to orientation and position changes of the first anatomical feature in the additional frames of the video with respect to a first frame of the video.

14. The method of claim 1 wherein the video comprises a motion picture.

15. The method of claim 1 wherein the first anatomical feature comprises a nose of the character and the second anatomical feature comprises a deformed version of the nose.

16. The method of claim 1 the first anatomical feature comprises an eye of the character and the second anatomical feature comprises a deformed version of the eye.

17. The method of claim 1 wherein the displaying the second anatomical feature in place of the first anatomical feature comprises a viewer induced jiggling of an anatomy of the character.

18. A machine readable medium having processor control instructions, the processor control instructions to control a processor to display a video, the processor control instructions further comprising:
instructions to display frames of a video on a display, the displayed frames of the video comprising a character image having a first anatomical feature;
instructions to receive an input with a user interface associated with the display;
instructions in response to the input to generate a second anatomical feature corresponding to the first anatomical feature, the second anatomical feature comprising a deformation of the first anatomical feature; and
instructions to display the second anatomical feature in place of the first anatomical feature during the video.

19. The machine readable medium of claim 18 wherein the instructions to generate the second anatomical feature further comprise instructions to detect pixels of the first anatomical feature of the video by scanning pixel data of a frame of the video.

20. The machine readable medium of claim 18 wherein the instructions to generate the second anatomical feature further comprise instructions to access metadata associated with the first anatomical feature of the video.

21. The machine readable medium of claim 20 wherein the metadata comprises frame identifier data to identify a frame containing the first anatomical feature and position data to identify positioning of the first anatomical feature.

22. The machine readable medium of claim 21 wherein the metadata further comprises action data indicative of a deformation procedure for the first anatomical feature.

23. The machine readable medium of claim 18 wherein the instructions to display the second anatomical feature comprise instructions to overlay at least in part the second anatomical feature with the first anatomical feature.

24. The machine readable medium of claim 23 wherein the instructions to overlay do not modify any frame of the video.

25. The machine readable medium of claim 18 wherein the instructions to display frames of the video further comprise instructions to display a deformation area indicator to indicate an anatomical feature of the video that can be subjected to viewer deformation.

26. The machine readable medium of claim 18 wherein the input comprises a command to generate the second anatomical feature with a change in size of the first anatomical feature.

27. The machine readable medium of claim 18 wherein the input comprises a command to generate the second anatomical feature with a change in orientation of the first anatomical feature.

28. The machine readable medium of claim 18 wherein the processor control instructions further comprise:
instructions to store deformation data corresponding to the generated deformations of the first anatomical feature of the video in a file separate from the video.

29. The machine readable medium of claim 28 wherein the processor control instructions further comprise instructions to transfer the file of the stored deformation data in a format to permit a viewer of another copy of the video to display the second anatomical feature in place of the first anatomical feature during the viewer's display of the copy of the video.

30. The machine readable medium of claim 18 wherein the processor control instructions further comprise instructions to automatically generate modifications of the second anatomical feature for additional frames of the video, the modifications corresponding to orientation and position changes of the first anatomical feature in the additional frames of the video with respect to a first frame of the video.

31. The machine readable medium of claim 18 wherein the video comprises a motion picture stored on the machine readable medium.

32. The machine readable medium of claim 18 wherein the first anatomical feature comprises a nose of the character and the second anatomical feature comprises a deformed version of the nose.

33. The machine readable medium of claim 18 wherein the first anatomical feature comprises an eye of the character and the second anatomical feature comprises a deformed version of the eye.

34. The machine readable medium of claim 18 wherein the instructions to display the second anatomical feature in place of the first anatomical feature comprise a viewer induced jiggling of an anatomy of the character.

35. A video player apparatus comprising:
an output port to send signals to a video display;
a user interface to receive an input with a user interface associated with the display; and
a processing means for controlling a display of frames of a video on a display, the video frames comprising a character image having a first anatomical feature;
the processing means being further configured for generating a second anatomical feature corresponding to the first anatomical feature in response to the input of the user interface, the second anatomical feature comprising a deformation of the first anatomical feature; and
the processing means being further configured for displaying the second anatomical feature in place of the first anatomical feature during the video.

36. The video player apparatus of claim 35 wherein the input comprises a command to generate the second anatomical feature with a change in size of the first anatomical feature.

37. The video player apparatus of claim 35 wherein the input comprises a command to generate the second anatomical feature with a change in orientation of the first anatomical feature.

38. The video player apparatus of claim 35 wherein the processing means is further configured for storing deformation data corresponding to the generated deformations of the first anatomical feature of the video in a file separate from the video.

39. The video player apparatus of claim 38 wherein the processing means is further configured for transferring the file of the stored deformation data in a format to permit a viewer of another copy of the video to display the second anatomical feature in place of the first anatomical feature during the viewer's display of the copy of the video.

40. The video player apparatus of claim 35 wherein the processing means is further configured for automatically generating modifications of the second anatomical feature for additional frames of the video, the modifications corresponding to orientation and position changes of the first anatomical feature in the additional frames of the video with respect to a first frame of the video.
